(19) United States
(12) Patent Application Publication
(10) Pub. No.: US 2009/0301055 A1
(43) Pub. Date: Dec. 10, 2009

(54) Gas Turbine Engine Systems and Methods Involving Vibration Monitoring

(75) Inventor: Pattada A. Kallappa, Hartford, CT (US)

Correspondence Address: O''Shea Getz P.C., 1500 MAIN ST. SUITE 912, SPRINGFIELD, MA, 01115, US

(73) Assignee: UNITED TECHNOLOGIES CORP., Hartford, CT (US)

(21) Appl. No.: 12/132,847

(22) Filed: Jun. 4, 2008

(51) Int. Cl. F02C 7/00; G01M 15/14

(52) U.S. Cl. 60/39.091; 73/660

(57) ABSTRACT

Gas turbine engine systems and methods involving vibration monitoring are provided. In this regard, a representative vibration monitoring method for a gas turbine engine includes: receiving information corresponding to detected vibrations of a gas turbine engine; isolating vibrations attributable to rotating blades of the gas turbine engine from the detected vibrations; and comparing the isolated vibrations to information corresponding to predicted vibrations of the rotating blades.

### STATEMENT REGARDING FEDERALLY SPONSORED RESEARCH AND DEVELOPMENT

The U.S. Government may have an interest in the subject matter of this disclosure as provided for by the terms of contract number N00019-02-C-30003 awarded by the United States Navy.

### BACKGROUND

1. Technical Field

The disclosure generally relates to gas turbine engines.

2. Description of the Related Art

There are various factors that influence the operating life of gas turbine engine components. By way of example, the environment in which a gas turbine engine operates can have a significant impact. For instance, a salt-rich environment, such as experienced during transoceanic flights, can result in increased oxidation of components.

In contrast to environmental factors, other factors that influence the operating life of a gas turbine can be internal to the gas turbine. By way of example, vibrating gas turbine engine components can cause high cycle fatigue (HCF). That is, rotating components such as bearings, shafts and rotor assemblies (including gearboxes) can experience excessive frequency-related loading during periods of abnormally high vibration that tends to reduce the operating life of these components.

### SUMMARY

Gas turbine engine systems and methods involving vibration monitoring are provided. In this regard, an exemplary embodiment of a vibration monitoring system for a gas turbine engine comprises: a vibration sensor operative to detect vibrations of a gas turbine engine and to output signals corresponding to the vibrations detected; and a vibration analysis system operative to: receive the information corresponding to the vibrations detected by the vibration sensor; isolate vibrations attributable to rotating blades of the gas turbine engine; and compare the isolated vibrations to information corresponding to predicted vibrations of the rotating blades.

An exemplary embodiment of a gas turbine engine comprises: rotatable blades; and a vibration monitoring system operative to: receive information corresponding to vibrations of the gas turbine engine; isolate vibrations attributable to rotations of the blades; and compare the isolated vibrations to information corresponding to predicted vibrations of the blades.

An exemplary embodiment of a vibration monitoring method for a gas turbine engine comprises: receiving information corresponding to detected vibrations of a gas turbine engine; isolating vibrations attributable to rotating blades of the gas turbine engine from the detected vibrations; and comparing the isolated vibrations to information corresponding to predicted vibrations of the rotating blades.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram depicting an exemplary embodiment of a gas turbine engine.

FIG. 2 is a flowchart depicting an exemplary embodiment of a method involving vibration monitoring.

FIG. 3 is a flowchart depicting another exemplary embodiment of a method involving vibration monitoring.

FIGS. 4A-4C are graphs depicting time synchronous averaging of a representative signal.

FIG. 5 is a schematic diagram depicting rotating blades and a vibration sensor.

FIG. 6 is a graph depicting a time synchronous averaged vibration signal corresponding to the rotating blades of FIG. 5.

FIG. 7 is a graph depicting a time synchronous averaged vibration signal for rotating blades exhibiting blade flutter.

FIG. 8 is a representative Campbell diagram containing information that can be used during vibration analysis.

### DETAILED DESCRIPTION

Gas turbine engine systems and methods involving vibration monitoring are provided, several exemplary embodiments of which will be described in detail. In some embodiments, signal processing techniques are used to reduce noise that typically accompanies information acquired by vibration sensors. The acquired information is then compared to predicted vibrations expected of blades of the gas turbine engine, such as predicted vibratory response of the blades (e.g. turbine blades) at given rotational speeds. Differences between the detected and predicted vibrations can be indicative of various degradations, such as crack initiation and/or propagation. Notably, in some embodiments, the predicted vibrations can be based on modeling and/or sampling of on-condition operations.

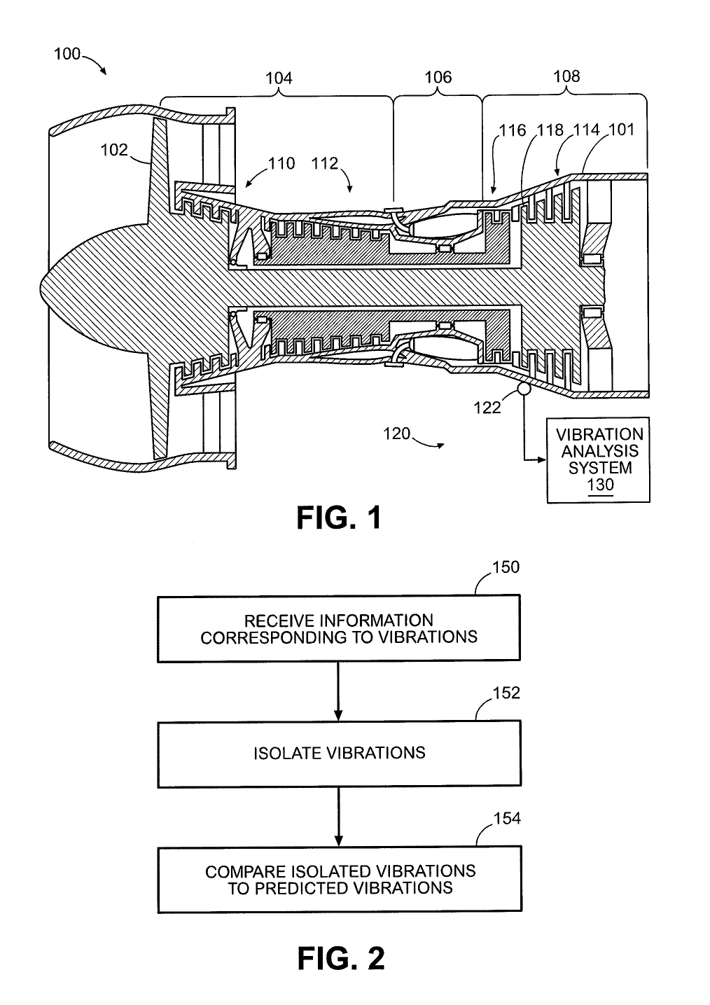

In this regard, reference is made to the schematic diagram of FIG. 1, which depicts an exemplary embodiment of a gas turbine engine. As shown in FIG. 1, engine 100 is depicted as a turbofan that incorporates an engine casing 101, a fan 102, a compressor section 104, a combustion section 106 and a turbine section 108. Compressor section 106 includes a low pressure compressor 110 and a high pressure compressor 112, and turbine section 108 includes a low pressure turbine 114 and a high pressure turbine 116. Notably, each of the compressors and turbines includes rotating blades. For instance, turbine 114 includes a blade 118. Although depicted as a dual spool turbofan gas turbine engine, it should be understood that the concepts described herein are not limited to use with dual spool turbofans, as the teachings may be applied to other types and configurations of gas turbine engines.

Engine 100 also incorporates a vibration monitoring system 120 that includes a vibration sensor 122 and a vibration analysis system 130. In this embodiment, vibration sensor 112 is attached to engine casing 101 and is used to detect vibrations (e.g., vibrations associated with the blades of the low pressure turbine). In this embodiment, the vibration sensor is a high bandwidth piezoelectric accelerometer with a vibration detection range of up to approximately 30 kHz. As such, sensor 122 may be able to detect up to approximately 8 harmonics of an expected blade pass frequency, i.e., the frequency at which the blades pass an arbitrary location during rotation. Notably, various other types, locations and numbers of vibration sensors can be used in other embodiments.

Vibration sensor 122 outputs signals that contain information corresponding to the vibrations detected. Vibration analysis system 130 receives the information, either directly or indirectly, from the vibration sensor and attempts to isolate vibrations attributable to the rotating blades of the engine. The detected vibrations are then correlated with predicted vibrations of the rotating blades in order to determine whether or not the blades are exhibiting expected characteristics. By way of example, a magnitude of the blade pass frequency or the magnitude of a blade resonance frequency can be compared to corresponding predicted values at a given rotational speed of the engine. A lack of correlation beyond a predetermined threshold may be indicative of a fault mode of the blades, such as one or more of the blades exhibiting cracks and/or otherwise being deformed. By way of further example, a trend associated with the magnitude (e.g., an unexpected change over time) also may be indicative of a fault mode of the blades.

FIG. 2 is a flowchart depicting an exemplary embodiment of a method involving vibration monitoring. As shown in FIG. 2, the method (which may be associated with the functionality of a vibration monitoring system) may be construed as beginning at block 150, in which information corresponding to vibrations is received. In block 152, vibrations attributable to rotating blades of the gas turbine engine are isolated. By way of example, in some embodiments, blade-pass filtering can be used to isolate these vibrations. In block 154, the isolated vibrations are compared to information corresponding to predicted vibrations of the rotating blades. In some embodiments, analysis of the vibrations can be conducted in one or both of the time and frequency domains.

In some embodiments, a vibration monitoring system combines a wide range of analytical concepts, engineering principles, digital signal processing techniques and mathematical principles to provide a measure of blade status health.

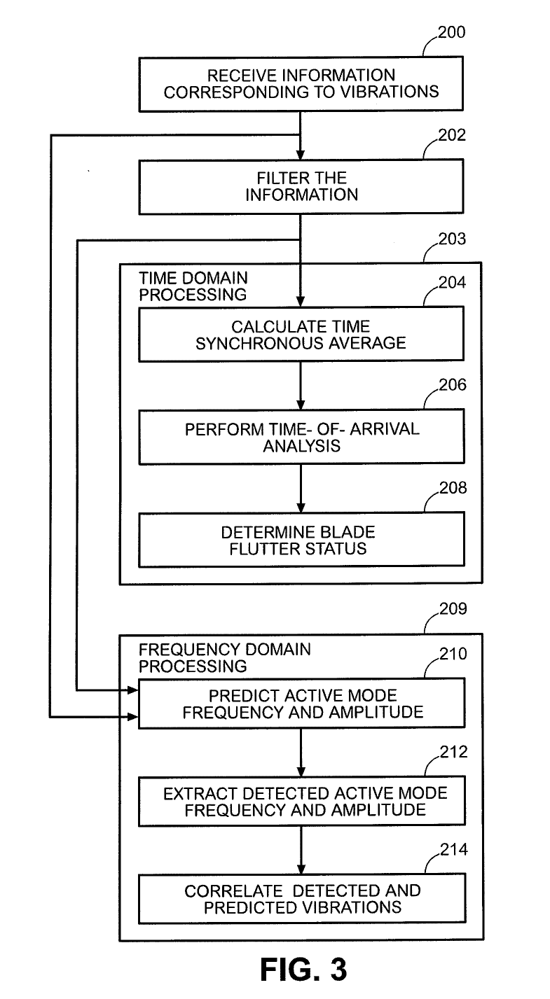

FIG. 3 is a flowchart depicting another exemplary embodiment of a method involving vibration monitoring. As shown in FIG. 3, the method (which may be associated with the functionality of a vibration analysis system) may be construed as beginning at block 200, in which information corresponding to vibrations is received. By way of example, the information may be in the form of an output signal provided by a vibration sensor.

In block 202, the information is filtered. Specifically, in this embodiment, the information is filtered in order to isolate the blade pass frequency of interest along with the sidebands that correspond to the critical-to-failure blade modes. In some embodiments, this can be accomplished by focusing in on a frequency band centered around the blade pass frequency to isolate the blade vibration frequency and a predetermined bandwidth around the blade vibration frequency. Notably, the blade pass frequency is the shaft frequency multiplied by the number of blades on the shaft. In some embodiments, this band centered around the blade pass frequency is isolated from the vibration signal using a band pass filter. The bandwidth of the band pass filter is selected as twice the highest blade mode that is considered critical for blade failure. For example, for a shaft rotating at 60 Hz frequency that has 10 blades, the blade-pass frequency is 60*10=600 Hz. If the highest blade mode critical to blade failure is 200 Hz, the band pass filter could exhibit a pass band from 400 Hz to 800 Hz, with 400 Hz as the lowest frequency of interest and 800 Hz as the highest frequency of interest. In some embodiments, the vibration signal received by block 200 is received through an analog-to-digital converter, digitized and provided for the downstream blocks. In these embodiments, the analog-to-digital sampling rate is greater than twice the highest frequency of interest.

Thereafter, analysis proceeds in one or both of the time and frequency domains. In some embodiments, a vibration monitoring system can perform frequency domain analysis in parallel with time domain analysis. In others, it can perform the two analyses sequentially.

Time domain processing encapsulated within block 203 in FIG. 3 is targeted at determining the time of arrival of blades and inferring blade flutter using the blade pass frequency band. The time domain analysis uses a noise reduction technique called time synchronous averaging to remove aspects of a vibration signal not consistent with rotation of the blades of interest. The noise-reduced signal is then analyzed using time-of-arrival analysis to detect amount of blade flutter exhibited by the blades. Notably, the time-of-arrival for any blade deviates from an expected average value when exhibiting blade flutter due to cracks or other blade degradations.

With respect to time domain analysis, the process may proceed to block 204 in FIG. 3, in which the time synchronous average is calculated. The time synchronous average (TSA) is acquired by mathematical data/signal processing, in which a signal is averaged in a buffer in the time domain. Specifically, the processing is used to reduce the effects of unwanted noise in the measurement. In order to perform time synchronous averaging, a reference trigger pulse can be used as an input to an analyzer to initiate sampling of a signal. If the trigger pulse is synchronized with a repetition rate of the signal, the averaging process will gradually eliminate any noise that is not synchronized with the trigger. In contrast, portions of the signal that are synchronous with the trigger are emphasized.

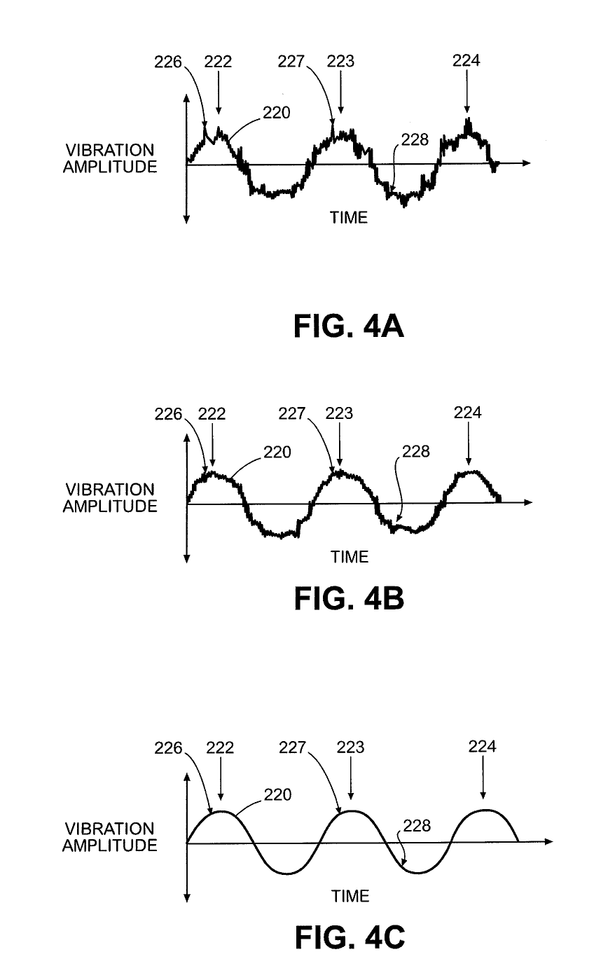

Time synchronous averaging of a representative signal is depicted in FIGS. 4A-4C. In this example, the signal is plotted with respect to vibration amplitude versus time for a rotating shaft with three blades. In FIG. 4A, signal 220 is depicted, which is unfiltered and which contains information corresponding to the sensed vibrations of the rotating shaft. Notably, signal 220 exhibits three major peaks 222, 223 and 224 corresponding to passage of three blades on a shaft. However, this signal is unsmooth and jagged because of many noise related peaks and valleys including peaks 226, and 227 and valley 228, which when they are large enough can mask the blade signal and limit use of the signal. The goal of TSA is to remove the noise peaks and valleys such as 226, 227 and 228, thus making it a smooth signal and leaving peaks corresponding to blade passage, such as 222, 223, and 224 intact.

In FIG. 4B, time synchronous averaging is performed with a trigger pulse synchronized with shaft rotation. For example, FIG. 4B may depict the signal after averaging of 10 rotations. As shown in FIG. 4B, peaks 222, 223 and 224 are still evident; however, noise associated with the signal is reduced, thus reducing the magnitude of noise peaks 226 and 227 and noise valley 228. As shown in FIG. 4C, continued time synchronous averaging results in further noise reduction where peaks and valley 226, 227 and 228 are removed while the blade pass peaks 222, 223 and 224 are intact. For example, FIG. 4C may depict the signal after averaging of 100 rotations.

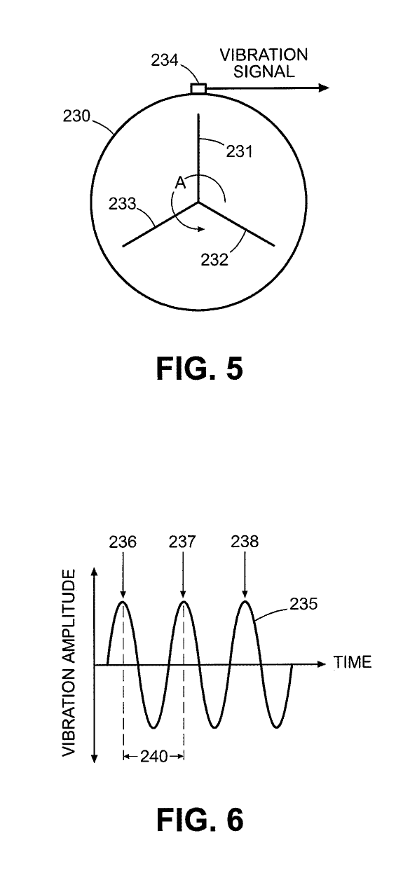

Referring back to FIG. 3, time of arrival analysis is performed in block 206. Time of arrival analysis calculates the time taken (in the context of blade passage) by consecutive blades to pass a particular point during rotation, e.g., a location on a surrounding fixed casing. This time is denoted as the time of arrival of the following blade. An example of time of arrival analysis is represented in FIGS. 5 and 6.

As shown in FIG. 5, an engine casing 230 surrounds rotating blades 231, 232 and 233 that rotate in the direction indicated by arrow A. A vibration sensor 234 is positioned on the casing. This sensor may even be positioned remotely or at another point on the casing. The time of arrival of blade 232 relative to sensor 234 is the amount of time that it takes for blade 232 to rotate to the location currently occupied by blade 231. As each blade passes the sensor location, a time synchronous averaged (TSA) vibration signal 235 (depicted in FIG. 6) shows peaks, each of which corresponds to passing of the sensor by one of the blades. In this case, peak 236 corresponds to passage of blade 231, peak 237 corresponds to blade 232, and peak 238 corresponds to blade 233. Within this TSA vibration signal, the distance between two consecutive peaks is the time of arrival for the following blade. By way of example, distance 240 corresponds to the time of arrival of blade 232.

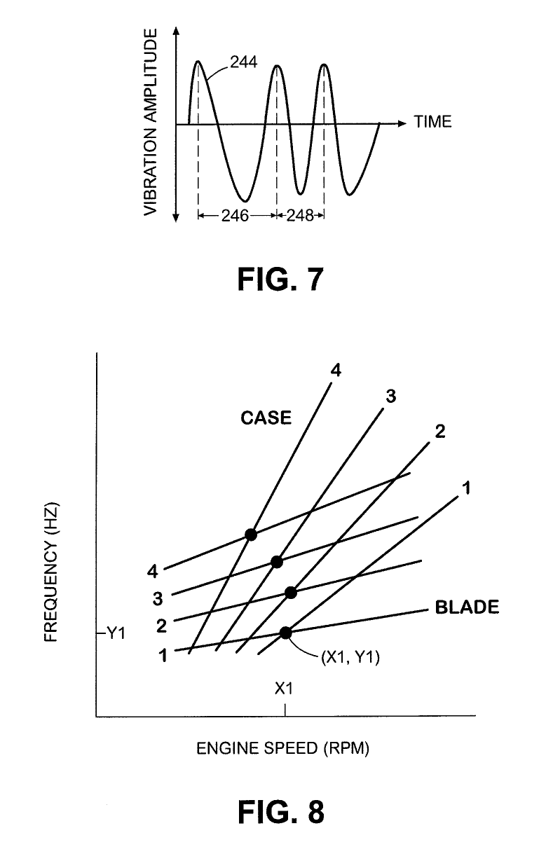

Referring again to FIG. 3 and as depicted in block 208, blade flutter status is determined. In this embodiment, the blade flutter status is determined by calculating the time of arrival of each blade cycling past a vibration sensor. Notably, the times of arrival depicted in FIG. 6 are evenly spaced and, therefore, do not exhibit flutter. In contrast, FIG. 7 depicts a TSA vibration signal 244 exhibiting indications of blade flutter. Specifically, blade flutter alters the time of arrival of a blade. Thus, the times of arrival of the adjacent blades differs. Notably, distance 246 is different from distance 248. For a healthy set of blades on a shaft, the time of arrival of each blade will be the same. The actual determination of blade flutter for an engine with multiple stages of fan compressor and turbines, each stage with many blades is a cumbersome process. Therefore, it becomes computationally cumbersome to capture the time of arrival of each and every blade and to analyze trends in order to see there is increasing variation. In order to make this more efficient, in some embodiments, the time of arrival of all blades for one or a few rotations can be stored, and the second statistical moment (standard deviation) and fourth statistical moment (kurtosis) can be calculated and evaluated for blade flutter analysis. Notably, an increase in kurtosis implies an incipient blade flutter and beginnings of a blade fault and an increase in standard deviation implies the growth of this fault to advanced levels in which immediate inspection and maintenance may be required.

In some embodiments, subsequent to time domain analysis trending can be performed to note if blade flutter related values like time-of-arrival and its standard deviation and kurtosis are increasing. Identified trends then can be correlated against expected trends to obtain status of the blades.

In some embodiments, a vibration monitoring system can perform frequency domain analysis as depicted within FIG. 3 block 209, to estimate if any active blade modes (also know as “active blade characteristic frequencies” or “active blade resonance frequencies”) exhibit higher than expected magnitudes, within the vibration signal. The magnitude of the active blade modes typically increases with an increase in blade flutter and/or blade crack. Additionally or alternatively, a shift in the active modes also can be exhibited, such as with crack growth (i.e., the active blade resonance frequency may shift over time). Thus, frequency domain analysis may involve checks for active mode magnitude change and frequency shift. In some embodiments, frequency domain analysis can involve analyzing the blade pass filtered vibration signal for active mode magnitude change and frequency shift (i.e., the process depicted in FIG. 3 may proceed from block 202 to block 209). In other embodiments, or simultaneously, frequency domain analysis can also involve analyzing unfiltered vibration data to review active mode magnitude change and frequency shift, in which case the process depicted in FIG. 3 may proceed from 200 to 209.

In block 210, information corresponding to rotational speed of the engine is used to predict the expected active modes and their corresponding expected/predicted frequency and magnitude. By way of example, a determination can be made as to which of the blade modes are expected to be active at any instant. Since excitation is driven by the associated blade shaft rotation frequency, blade shaft rotations per minute (RPM) is used along with pre-existing blade design data to determine the expected active blade modes and their expected frequency and magnitude. In some embodiments, information contained in a Campbell diagram can be used as a look-up source for determining these expected active modes. An exemplary Campbell diagram is depicted in FIG. 8.

A Campbell diagram is a mathematically constructed diagram used to check for coincidence of vibration source frequency with natural resonances or modes. Such a Campbell diagram illustrates the modes of an object (e.g., a fan, compressor or turbine rotor blade) and its common exciting forces. The common exciting forces are the sources of vibration that provide an excitation frequency. In an aircraft engine, these sources of vibration can include the rotating shafts or spools on which the fans, compressors or turbine rotor blades are mounted. The excitation frequency is the rotational frequency of these sources, commonly termed as engine speed with units as RPM. The Campbell diagram can be used to determine whether an excitation source frequency coincides with the natural frequency or mode of the object. When an excitation source coincides with a mode that mode becomes the active mode. Within this context, at any operating speed, a Campbell diagram may indicate what levels of vibration and at what frequencies those vibrations are expected to be present in a measured vibration signal. For instance, at an engine RPM of X1, both the blade and case are expected to exhibit frequencies of Y1 (indicated by collocation of blade curve 1 and case curve 1 at location (X1, Y1)). If the actual vibration signal differs from this measurement, this can be indicative of a fault. If trending indicates that this difference increases with passage of time, this can be indicative of a growing fault.

With further reference to FIG. 3, after receiving the expected value of the active mode frequency and magnitude, the frequency domain analysis proceeds to box 212. In block 212, the exhibited or detected frequency and magnitude related to the expected active modes from the blade pass filtered and/or the unfiltered signal are extracted. In some embodiments, this information is extracted from the respective signals after calculating their spectrum/Fourier transform/Fast Fourier Transform (FFT). Notably, within the blade pass filtered signal, the active blade modes typically appear as sidebands around the blade pass frequency in the FFT. Rectification of the signal, prior to FFT calculation, moves these sidebands to their actual frequency values in the FFT. For example, if the blade-pass frequency is 600 Hz and the active mode is at 150 Hz, then in the blade-pass signal, the active modes appear at: 600−150=450 Hz and 600+150=750 Hz. Rectification of the signal shifts this active mode to the actual frequency of 150 Hz. For this reason, in some embodiments, the blade pass filtered signal is rectified to move the sidebands to their actual values, prior to FFT calculation.

Within frequency domain analysis (block 214 of FIG. 3), the detected frequency and amplitude corresponding to the active mode are correlated to their expected/predicted values. A poor correlation is indicative of blade cracks. In some embodiments, this analysis may be used to determine whether: the active blade mode amplitude is higher than expected; the amplitude shows an increasing trend; the active mode frequency has shifted from its expected value; and/or the active mode is showing a trend towards gradually shifting, for example.

Various embodiments of a vibration monitoring system are applicable to turbofan, turboprop and turboshaft engines. Most such engines have fans, compressors and turbines, with one or more of these including multiple stages, with each stage incorporating a corresponding set of rotating blades. In turboshaft or helicopter engines, such a system can be used for both main and tail rotor blades. Embodiments also can be used on other open rotor systems, such as propeller blades on a turboprop engine. Notably, embodiments may be particularly well suited for use with hot sections, due to non-intrusiveness and an ability to monitor harsh high temperature environments remotely, without being subject to sensor survivability issues associated with such an environment.

With respect to such a sensor, a typical sensor can be a high bandwidth accelerometer with a range of up to a few harmonics of the blade pass frequency of interest. For a medium-sized turbofan engine, this could be approximately 30 KHz. While sensor location can be used to better target a particular rotating stage of a component, in some embodiments, a sensor can monitor the entire engine from a location on the engine casing, for example. In some embodiments, an analog to digital (A/D) conversion rate of twice the sensor bandwidth can be used; however, a sensor of lower bandwidth and A/D conversion lower than twice that bandwidth can be used in other embodiments.

Various functionality (such as that described above in the flowcharts and/or otherwise attributable to a vibration analysis system) can be implemented in hardware and/or software. In this regard, a computing device can be used to implement various functionality, such as that depicted in FIGS. 2 and 3.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the functionality described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” contains, stores, communicates, propagates and/or transports the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of a computer-readable medium include a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical).

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. A vibration monitoring system for a gas turbine engine comprising:
a vibration sensor operative to detect vibrations of a gas turbine engine and to output signals corresponding to the vibrations detected; and
a vibration analysis system operative to:
receive the information corresponding to the vibrations detected by the vibration sensor;
isolate vibrations attributable to rotating blades of the gas turbine engine; and
compare the isolated vibrations to information corresponding to predicted vibrations of the rotating blades.

2. The system of claim 1, wherein the vibration analysis system is operative to:
determine a blade pass frequency of the rotating blades; and
determine whether a magnitude of the blade pass frequency corresponds to a threshold indicative of a fault mode of the blades.

3. The system of claim 1, wherein the vibration analysis system is operative to:
determine a blade pass frequency of the rotating blades; and
determine whether a trend associated with the blade pass frequency over time is indicative of a fault mode of the blades.

4. The system of claim 1, wherein the vibration sensor is a high bandwidth vibration sensor having a vibration detection range of up to approximately 30 kHz.

5. The system of claim 1, wherein the vibration sensor is a piezoelectric accelerometer.

6. The system of claim 1, wherein, in comparing the isolated vibrations to information corresponding to predicted vibrations of the rotating blades, the vibration analysis system is operative to correlate the isolated vibrations with an associated rotational speed of the blades.

7. The system of claim 1, wherein, in isolating the vibrations attributable to the rotating blades, the vibration analysis system is operative to calculate the time synchronous average of the rotating blades.

8. The system of claim 1, wherein, in isolating the vibrations attributable to the rotating blades, the vibration analysis system is operative to perform time of arrival analysis with respect to the rotating blades.

9. The system of claim 1, wherein, in comparing the isolated vibrations to information corresponding to predicted vibrations of the rotating blades, the vibration analysis system is operative to compare the isolated vibrations to predicted active blade frequencies at corresponding rotational speeds of the blades.

10. The system of claim 9, wherein, in comparing the isolated vibrations to predicted active blade frequencies at corresponding rotational speeds of the blades, the vibration analysis system is operative to use a Campbell Diagram.

11. A gas turbine engine comprising:
rotatable blades; and
a vibration monitoring system operative to:
receive information corresponding to vibrations of the gas turbine engine;
isolate vibrations attributable to rotations of the blades; and
compare the isolated vibrations to information corresponding to predicted vibrations of the blades.

12. The engine of claim 11, further comprising a vibration sensor operative to detect the vibrations of a gas turbine engine and to output signals containing the information corresponding to the vibrations detected.

13. The engine of claim 12, wherein:
the engine has an engine casing located radially outboard of the blades; and
the vibration sensor is mounted to the engine casing.

14. The engine of claim 13, wherein the vibration sensor is a high bandwidth piezoelectric accelerometer.

15. The engine of claim 11, wherein the engine is a turbofan gas turbine engine.

16. A vibration monitoring method for a gas turbine engine comprising:
receiving information corresponding to detected vibrations of a gas turbine engine;
isolating vibrations attributable to rotating blades of the gas turbine engine from the detected vibrations; and
comparing the isolated vibrations to information corresponding to predicted vibrations of the rotating blades.

17. The method of claim 16, wherein, in comparing the isolated vibrations to information corresponding to predicted vibrations of the rotating blades, the isolated vibrations are correlated with an associated rotational speed of the blades.

18. The method of claim 16, wherein comparing comprises:
determining a blade pass frequency of the rotating blades; and
determining whether a magnitude of the blade pass frequency corresponds to a threshold indicative of a fault mode of the blades.

19. The method of claim 16, wherein comparing comprises:
determining a blade pass frequency of the rotating blades; and
determining whether a trend associated with the blade pass frequency over time is indicative of a fault mode of the blades.

20. The method of claim 16, wherein, in isolating the vibrations attributable to the rotating blades, a time synchronous average of the rotating blades is calculated and time of arrival analysis is performed with respect to the rotating blades.
